(19) United States
(12) Patent Application Publication
(10) Pub. No.: US 2019/0225875 A1
(43) Pub. Date: Jul. 25, 2019

(54) USE OF POLYHEDRAL OLIGOMERIC SILSESQUIOXANE TO INCREASE THE VISCOSITY OF WELL TREATMENT FLUIDS

(71) Applicant: Halliburton Energy Services, Inc., Houston, TX (US)

(72) Inventors: Dipti Singh, Kingwood, TX (US); Enrique Antonio Reyes, Tomball, TX (US)

(21) Appl. No.: 16/340,355

(22) PCT Filed: Nov. 9, 2016
(86) PCT No.: PCT/US2016/061121

§ 371 Date: Apr. 8, 2019

(51) Int. Cl. C09K 8/68; E21B 43/26; E21B 43/267; C09K 8/80

(52) U.S. Cl. CPC C09K 8/685; C09K 8/80; E21B 43/267; E21B 43/26

(57) ABSTRACT

A well treatment fluid comprising a base fluid and a viscosifying agent for increasing the viscosity of the well treatment fluid is provided. The viscosifying agent comprises a plurality of polyhedral oligomeric silsesquioxane particles that each contain at least one reactive functional end group. A method of treating a subterranean formation penetrated by a wellbore is also provided. In one embodiment, the method of treating a subterranean formation penetrated by a wellbore is a method of fracturing a subterranean formation penetrated by a wellbore.

### BACKGROUND

Well treatment fluids are introduced into wellbores and pumped through wellbores into subterranean formations in a variety of different applications. For example, well treatment fluids are often used to fracture, acidize, and otherwise stimulate production from subterranean formations. By way of further example, well treatment fluids are also used to form gravel packs, diverter plugs and proppant packs in wellbores and/or subterranean formations.

In many applications, it is important for the viscosity of the well treatment fluid to be increased. For example, higher viscosity drilling and other fluids can more effectively carry materials out of the wellbore. Similarly, for example, higher viscosity fracturing fluids can more effectively fracture the formation and carry proppant particulates into the fracture.

Viscosified well treatment fluids are particularly useful in hydraulic fracturing operations. Hydraulic fracturing generally involves pumping a fracturing fluid into the formation at a sufficient hydraulic pressure to create or enhance one or more fractures in the formation. Typically, a fracturing fluid that does not contain conventional or primary proppant particulates (a “pad fluid”) is first injected into the formation to initially fracture the formation. Thereafter, a fracturing fluid that does contain conventional or primary proppant particulates (a “proppant slurry”) is injected into the formation. The proppant slurry places the proppant particulates in the fracture in order to prevent the fracture from fully closing once the hydraulic pressure created by the fluid is released and the fracturing operation is complete. The resulting propped fracture provides one or more conductive channels through which fluids in the formation can flow from the formation to the wellbore. For example, viscosifying the proppant slurry allows proppant particulates to be more easily suspended in the slurry and transported into the fracture.

The use of viscosified well treatment fluids in tight or low permeability formations such as shale, sandstone and coal bed formations requires special considerations. Shale, sandstone and coal bed formations can have permeabilities as low as approximately one millidarcy (mD) or less. For example, hydraulically fracturing such formations typically forms a complex fracture network in a zone of the formation surrounding the wellbore that includes primary fractures and microfractures. For example, microfractures can extend from a tip and edges of a primary fracture or a branch thereof and extend outwardly in a branching tree-like manner from the primary fracture. Microfractures can exist and be formed in both near-wellbore and far-field regions of the zone, as well as regions located adjacent to primary fracture branches. As a result, the microfractures can give more depth and breadth to the fracture network.

Conventional proppant particulates are often too large to be placed into microfractures to prop the microfractures open. In order to address this issue, micro-proppant particulates having a size sufficient to allow the particulates to be placed in microfractures have been developed. For example, in fracturing operations, micro-proppant particulates are often included in the pad fluid stages of the fracturing treatment to place micro-proppant particulates in the fissure openings to and otherwise in the microfractures as soon as they are opened or created. Conventional proppant particulates are then included in the proppant-slurry stages of the fracturing treatment and placed in the primary fractures and branches to help ensure that fluid conductive flow paths to the wellbore are maintained.

There is a need for viscosified well treatment fluids that can be efficiently used in tight or low permeability formations.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a diagram illustrating an example of a fracturing system that can be used in accordance with certain embodiments of the present disclosure.

FIG. 2 is a diagram illustrating an example of a subterranean formation in which a fracturing operation can be performed in accordance with certain embodiments of the present disclosure.

### DETAILED DESCRIPTION

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the disclosed subject matter. However, it will be understood by those of ordinary skill in the art that the subject matter described herein can be practiced without these specific details. In other instances, methods, procedures and components have not been described in detail so as not to obscure the related relevant feature being described. Also, the description is not to be considered as limiting the scope of the subject matter described herein. The drawings are not necessarily to scale and the proportions of certain parts may have been exaggerated to better illustrate details and features of the present disclosure.

In one aspect, the present disclosure is directed to a well treatment fluid. For example, the well treatment fluid can be used as a fracturing fluid to hydraulically fracture a subterranean formation. As another example, the well treatment fluid can be used to form a diverter plug in a wellbore and/or subterranean formation. As yet another example, the well treatment fluid can be used to both hydraulically fracture a subterranean formation and form a diverter plug in the wellbore and/or formation in a single operation.

In another aspect, the present disclosure is directed to a method of treating a subterranean formation penetrated by a wellbore. For example, the method can be used to hydraulically fracture a subterranean formation. As another example, the method can be used to form a diverter plug in a wellbore and/or subterranean formation. As yet another example, the method can be used to both hydraulically fracture a subterranean formation and form a diverter plug in the wellbore and/or formation in a single operation.

The well treatment fluid disclosed herein comprises a base fluid and a viscosifying agent for increasing the viscosity of the well treatment fluid. The viscosifying agent comprises a plurality of polyhedral oligomeric silsequioxane (“POSS”) particles that each contain at least one reactive functional end group. For example, the well treatment fluid can also include a dispersing agent to facilitate dispersion of the POSS particles in the base fluid.

The base fluid of the well treatment fluid can be a non-aqueous base fluid or an aqueous base fluid. The non-aqueous base fluid or aqueous base fluid can include a water-in-oil emulsion, an oil-in-water emulsion, or an aqueous-miscible fluid.

For example, the base fluid can be a non-aqueous base fluid. For example, the non-aqueous base fluid can be selected from the group of petroleum fractions such as alkanes, olefins, aromatic organic compounds, cyclic alkanes, paraffins, diesel fluids, mineral oils, kerosene (including desulfurized hydrogenated kerosene), and any combination thereof. For example, the non-aqueous base fluid can comprise one or more distilled petroleum fractions having a low viscosity and high flash point. For example, the non-aqueous base fluid can comprise a mixture of benzene (for example, ethylbenzene), toluene and xylene isomers (often referred to as “BTX” or “BTEX when ethylbenzene is used). For example, the non-aqueous base fluid can comprise one or more low toxicity drilling fluid oils made from hydrogenated fractionated petroleum. For example, the non-aqueous base fluid can comprise one or more natural oils such as soybean oil, corn oil, sunflower oil, safflower oil, peanut oil and any combination thereof.

Suitable aqueous-miscible fluids for use in connection with the base fluid of the well treatment fluid include alcohols such as methanol, ethanol, n-propanol, isopropanol, n-butanol, sec-butanol, isobutanol, and t-butanol; glycerins; glycols such as polyglycols, propylene glycol, and ethylene glycol; polyglycol amines; polyols; combinations of such compounds with salts such as sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, and sodium carbonate; and combinations thereof.

Suitable water-in-oil emulsions, also known as invert emulsions, for use in connection with the base fluid of the well treatment fluid may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base carrier fluid, where the amount may range from any lower limit to any upper limit and encompass any subset therebetween. It should be noted that for water-in-oil and oil-in-water emulsions, any mixture of the above may be used including the water being and/or comprising an aqueous-miscible fluid.

For example, the base fluid can be an aqueous base fluid. In this case, for example, the POSS particles can be derivatized to increase the hydrophilicity thereof. As used herein and in the appended claims, the term “derivatized” means modified such that a derivative of the compound is formed. Hydrophilicity means the tendency of a molecule to be solvated by water.

For example, the POSS particles can be derivatized to increase the hydrophilicity thereof by mixing the POSS particles with a compound selected from the group of poly(ethylene glycol) acrylate, poly(ethylene glycol) diacrylate, poly(ethylene glycol) methacrylate, acrylic acid, 2-hydroxyethyl methacrylate, 2-hydroxyethyl acrylate, 2-(2-ethoxyethoxy)ethyl acrylate, tetrahydrofurfuryl acrylate, compounds having an amino functional group, compounds having a carboxylate functional group, compounds having a silanol functional group, compounds having a carbinol functional group, compounds having a sulfonate functional group, compounds having a phosphonate functional group, and any combination thereof. For example, the POSS particles can be derivatized to increase the hydrophilicity thereof by mixing the POSS particles with isopropanol.

In most applications, the well treatment fluid in general and the base fluid of the well treatment fluid are aqueous-based. For example, the base fluid can be water. The water can come from a variety of sources. For example, the water can be fresh water, saltwater (for example, water containing one or more salts dissolved therein), brine (for example, saturated saltwater or produced water), seawater, brackish water, produced water (for example, water produced from a subterranean formation), formation water, treated flowback water, and mixtures thereof. Generally, the water can be from any source, provided that it does not contain components that might adversely affect the stability and/or performance of the well treatment fluid.

Examples of dispersing agents that can be used to facilitate dispersion of the POSS particles in an aqueous base fluid include low molecular weight (for example, 1,000 to 2,000 g/mol) polyacrylates, polyphosphates, copolymers of styrene/maleic anhydride, chemical iterations of such compounds, and any combination thereof. Additional examples of dispersing agents that can be used facilitate dispersion of the POSS particles in an aqueous base fluid include dodecylbenzenesulfonic acid, resins, glycolic acid, oxalic acid, malic acid, citric acid, pectins, amino acids, celluloses, polyacrylates, polyvinylbenzoates, polyvinyl sulfate, polyvinyl sulfonates including sulfonated styrene, polybisphenol carbonates, polybenzimidazoles, polypyridine, sulfonated polyethylene terephthalate, polyvinyl alcohol, polyethylene glycol, polypropylene glycol, and any combination thereof.

For example, the dispersing agent can be added to the well treatment fluid disclosed herein in an amount in the range of from about 0.05% to about 3% by weight, based on the weight of the well treatment fluid. For example, the dispersing agent can be added to the well treatment fluid in an amount in the range of from about 0.1% to about 1% by weight, based on the weight of the well treatment fluid.

A significant amount of dust can be associated with the POSS particles when they are in dry particle form. This can create safety and handling issues when the POSS particles are added to the base fluid at the well site.

For example, in order to prevent or minimize the dust associated with the POSS particles in dry form, the POSS particles can be pre-suspended in a slurry and transported to the well site in slurry form. The POSS particle-containing slurry can then be mixed with the base fluid to form the well treatment fluid disclosed herein. For example, the carrier fluid used to form the POSS particle-containing slurry can be the same as or compatible with the base fluid of the well treatment fluid disclosed herein.

An added benefit of pre-suspending the POSS particles in a slurry is it can make it easier to meter the amount of POSS particles added to the well treatment fluid, particularly when a relatively low concentration of POSS particles is used. It is easier to meter a slurry of the particles than it is to meter the particles in dry form.

### Polyhedral Oligomeric Silsequioxane (POSS)

POSS is a nanostructured cage-like or polymeric framework with Si—O—Si linkages and tetrahedral Si vertices. A representative structure of POSS is shown by structure (1) below:

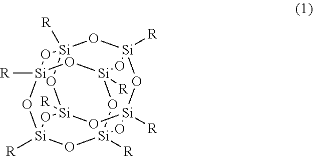

The R groups of the above formula are reactive functional end groups that can be derivatized or modified to provide a targeted effect, for example, a customizable chemical outcome such as bonding (adhesion) to a surface or particle growth to bridge or plug a microfracture. For example, the POSS particles can be functionalized or polymerized to induce changes in the glass transition temperature of a polymer and modify the mechanical properties of the polymer. The reactive functional end groups can be the same or can vary. For example, when crosslinked, the POSS particles can exhibit bulk properties that make it readily usable in bridging micro-fractures on the order of 100 microns or less.

As used in connection with the viscosifying agent of this disclosure, the polyhedral oligomeric silsequioxane is in the form of solid particles. The structure of POSS compounds can vary. The POSS used in connection with the viscosifying agent disclosed herein can be one structural form of POSS or multiple structural forms of POSS, as long as the POSS used has at least one reactive functional end group and is in particle form.

POSS is a polyorganosiloxane with a polyhedral chemical structure. The POSS used in connection with the viscosifying agent disclosed herein can have the average unit formula [R¹SiO_{3/2}], wherein at least one [R¹SiO_{3/2}] unit in the POSS is a reactive functional end group (“RFEG”).

The repeating unit of the POSS used herein can have the structure (2) below:

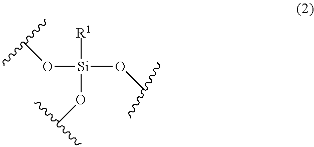

wherein each silicon-bonded oxygen is bonded to another silicon compound (e.g., silanol), a hydrogen atom, or an independently selected R¹ as defined herein. The POSS can have a total number of [R¹SiO_{3/2}] units selected from the group consisting of 6, 7, 8, 9, 10, 11, and 12. The POSS can be any suitable POSS. For example, the POSS can be a partially-caged or fully-caged POSS. Each corner of the POSS polyhedron can be occupied by a silicon atom, and each edge of the polyhedron can be formed by a Si—O—Si unit. The POSS can include at least three faces, with each face having a different plane, and with each face being defined as four interconnected [R¹SiO_{3/2}] units, for example, as shown by the structure (3) below:

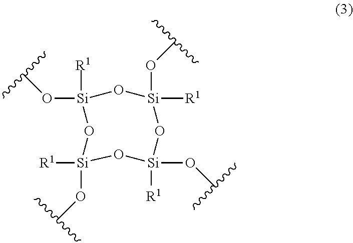

Examples of forms of POSS that can be used in connection with the viscosifying agent disclosed herein are shown by the structures (4), (5) and (6) below:

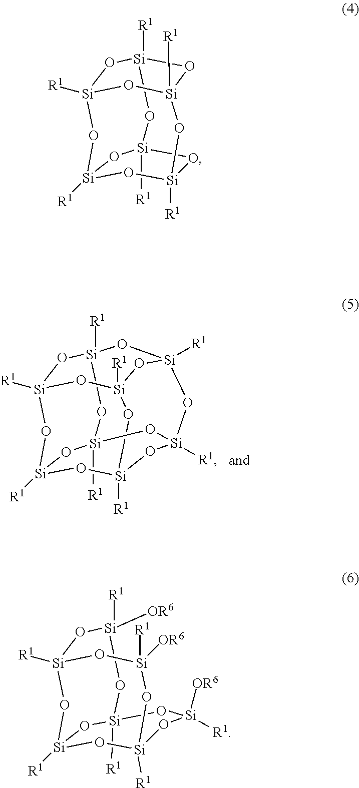

The variable R¹ at each occurrence can be independently selected from the group consisting of —R², -L-R², and -L-R³-R⁴. In some embodiments, at least one R¹ in the POSS structure is —(C₁-C₈)alkyl. At least one R¹ can be —(C₁-C₈)alkyl-RFEG. At least one R¹ can be —(C₁-C₈)alkyloxy(C₁-C₁₀)alkyl-RFEG. At least one R¹ can be —(C₁-C₈)alkyloxy(C₁-C₁₀)alkyl oxirane. At least one R¹ can be —O—Si(CH₃)₂(C₁-C₈)alkyloxy(C₁-C₁₀)alkyl-RFEG. At least one R¹ can be —O—Si(CH₃)₂(C₁-C₈)alkyloxy(C₁-C₁₀)alkyl oxirane. At least one R¹ can be —O-(ethyleneoxy)ₘ-(C₁-C₁₀)alkyl-RFEG wherein m is 1 to 1,000. At least one R¹ can be —O-(ethyleneoxy)ₘ-(C₁-C₁₀)alkyl oxirane wherein m is 1 to 50. At least one R¹ can be —O—Si(CH₃)₂—(CH₂)₃—O-glycidyl. For example, the POSS can be a fully caged cubic POSS (having eight R¹SiO_{3/2} units) with each of the eight R¹ variables equal to —O—Si(CH₃)₂—(CH₂)₃—O-glycidyl. At least one R¹ can be —O—Si(CH₃)₂—(CH₂)₂-epoxycyclohexyl. For example, the POSS can be a fully caged cubic POSS (having eight R¹SiO_{3/2} units) with each of the eight R¹ variables equal to —O—Si(CH₃)₂—(CH₂)₂-3,4-epoxycyclohexyl.

The variable R² at each occurrence can be independently selected from the group consisting of (C₁-C₃₀)hydrocarbyl, (C₁-C₃₀)hydrocarbylene-RFEG, and -RFEG, wherein each (C₁-C₃₀)hydrocarbyl and (C₁-C₃₀)hydrocarbylene is independently substituted or unsubstituted and is interrupted or terminated by 0, 1, 2, or 3 substituted or unsubstituted S, O, P, or N atoms (wherein an unsubstituted atom designates, e.g., the S, O, P, or N atom having no substituents or having —H thereon). In some embodiments, at least one R² in the POSS structure is (C₁-C₃₀)alkyl interrupted or terminated by 0, 1, 2, or 3 substituted or unsubstituted S, O, P, or N atoms. At least one R² can be (C₁-C₈)alkyl-RFEG. At least one R₂ can be (C₁-C₈)alkyl. At least one R₂ can be -RFEG.

The variable R³ at each occurrence can be independently —((C₂-C₈)alkyloxy)ₙ- wherein each alkyl group is independently substituted or unsubstituted and n is about 1 to about 1,000. In some embodiments, at least one R³ in the POSS structure is -(ethyleneoxy)ₙ- wherein n is about 1 to about 50.

The variable R⁴ at each occurrence can be independently selected from the group consisting of —H and R².

The variable L at each occurrence can be independently selected from a bond, —O—, —O—SiR¹₂—, —(O—SiR¹₂)ₘ—, —O—SiR¹₂—O—. The variable m can be about 2 to about 1,000. In some embodiments, at least one L in the POSS structure is —O—. At least one L can be —OSi((C₁-C₅)alkyl)₂-. At least one L can be —OSi(CH₃)₂—.

At each occurrence R⁶ can be independently selected from the group consisting of —H and R¹. At least one R¹ in the POSS includes an RFEG, the reactive functional end group.

For example, the reactive functional end group(s) (RFEG) of the POSS particles used in connection with the viscosifying agent disclosed herein can be selected from the group of hydroxyl groups, epoxy groups, amine groups, carboxyl groups, acetal groups, borate groups, boronic groups, boroxine groups, phosphate groups including orthophosphate groups, amine groups, amide groups, cyanate groups including isocyanate groups, hydrosilyl (H—SiR₂—) groups, hydroxysilyl (HO—SiR₂) groups, and silyl halide groups. For example, the reactive functional end group(s) (RFEG) of the POSS particles used in connection with the viscosifying agent disclosed herein can be selected from the group of hydroxyl groups, epoxy groups, amine groups, and carboxyl groups.

In another example, the POSS used herein can be a partially caged cubic POSS having the structure (7) below:

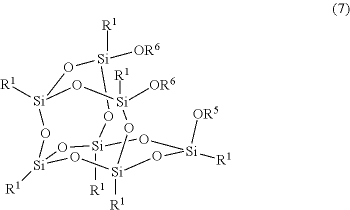

with seven R¹SiO_{3/2} units, with all three of the R⁶ variables equal to —Si(CH₃)₂—(CH₂)₃—O-glycidyl and with all seven R¹ equal to isobutyl. In another example, the POSS has the partially caged cubic structure having seven R¹SiO_{3/2} units, with all three of the R⁶ variables equal to —H and with all seven of the R₁ variables equal to —O—(CH₂)₂—O-glycidyl.

The silanol groups of a half-caged POSS can form strong bonds with particulates, including particulates formed of or containing sand or other silica-containing materials, fly ash, clay minerals (for example, kaolinite and bentonite), feldspathic minerals, quartz, bauxite, titanium oxide including titanium (II) oxide, titanium (III) oxide, titanium (IV) oxide (titanium dioxide or titania), and aluminum oxide (including Al—O₆, Al—O₅, Al—O₄, or Al—O₃ units.

One example of a structural form of POSS that can be used to form the POSS particles used herein is trimethylolpropane di-isobutyl polyhedral oligomeric silsequioxane. Trimethyloipropane di-isobutyl polyhedral oligomeric silsequioxane is shown by structure (8) below:

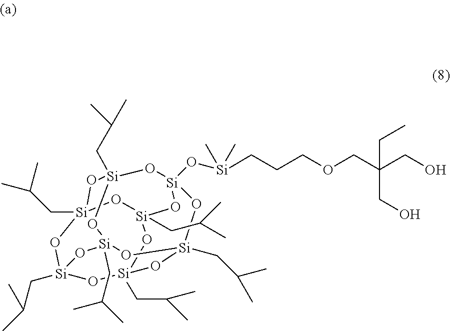 [SMILES: CCC(CO)(CO)COCCC[Si](C)(C)O[Si]12O[Si]3(CC(C)C)O[Si]4(CC(C)C)O[Si]5(CC(C)C)O[Si](CC(C)C)(O3)O[Si](CC(C)C)(O[Si](CC(C)C)(O5)O[Si](CC(C)C)(O4)O1)O2]

A large variety of additional structural forms of POSS and various combinations and permutations thereof can also be used to form the POSS particles used herein. Examples of reactive structures containing a terminal trialkylsiloxy or silanol functionality are shown by Structures (9) and (10) below:

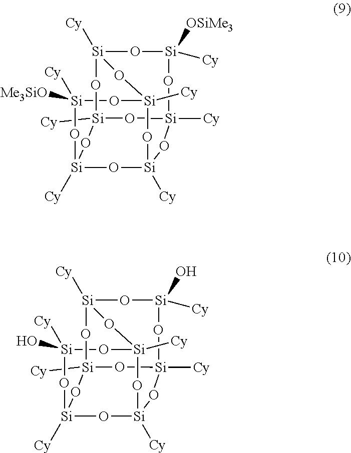

For example, the POSS particles used in connection with the well treatment fluid disclosed herein can have a D50 particulate size distribution in the range of from about 10 nanometers to about 100 micron. For example, the POSS particles used in connection with the well treatment fluid disclosed herein can have a D50 particulate size distribution in the range of from about 10 nanometers to about 10 microns. For example, the POSS particles used in connection with the well treatment fluid disclosed herein can have a D50 particulate size distribution in the range of from about 10 nanometers to about 1 micron. As used herein and in the appended claims, a “D50 particle size distribution” means the value of the particle diameter at 50% in the cumulative distribution.

For example, due to their small size, the POSS particles can access microfractures in very low to ultralow permeability (tight rock) formations. The structural functionality of the POSS particles allows the particles to react, as needed and desired, in the formations. For example, the reactive functional end group(s) of the POSS particles is chemically reactive and can provide the steering mechanism to control the chemistry of the particles at a higher level, such as expansion, adhesion, growth or stabilization. The degree of functionalization provides adaptable and customizable materials that operate preferentially within the foimation including microfractures in the formation.

For example, the fact that the POSS particles are silicates enhances the ability of the particles to be placed in microfractures, helps prevent the particles from being expelled from the microfractures during flow back of the well and makes the particles highly compatible with formation minerals. The particles do not tend to cause clay swelling and migration.

The fact that the POSS particles are insoluble or have low solubility in water facilitates their use in connection with diverting materials and propping agents, and makes them suitable for use in oil wetting conditions (without surface modification). The POSS particles can be tailored for self-degradation or susceptibility for degradation by, for example, acid.

### Viscosifying the Well Treatment Fluid

The POSS particles used in connection with the viscosifying agent disclosed herein increase the viscosity of the base fluid and well treatment fluid in general. For example, the POSS particles alone can provide a sufficient viscosity to allow the treatment fluid to fracture the formation and suspend particulates.

If desired, however, the viscosity of the base fluid and well treatment fluid in general can be increased by crosslinking the POSS. Accordingly, the viscosifying agent of the well treatment fluid disclosed herein can further comprise a crosslinker capable of reacting with the functional groups of the polyhedral oligomeric silsequioxane particles in order to crosslink the polyhedral oligomeric silsequioxane particles (hereafter referred to as a “POSS particle crosslinker”). Crosslinking the POSS particles further increases the viscosity of the base fluid and well treatment fluid.

For example, the POSS particle crosslinker can be selected from the group of aluminum crosslinkers, zirconium crosslinkers, titanium crosslinkers, boron crosslinkers and any combination thereof. For example, the crosslinker can be a boron crosslinker. For example, the crosslinker can be selected from the group of sodium metaborate and other metaborate crosslinkers, ulexite, monoethanolamine borate, and any combination thereof.

For example, the reactive functional end group of the polyhedral oligomeric silsequioxane particulate can be a hydroxyl group, and the crosslinker can be a borate crosslinker. The borate crosslinker reacts with the hydroxyl end groups of the POSS particles to crosslink the POSS particles and increase the viscosity of the well treatment fluid.

If desired, the viscosity of the base fluid and well treatment fluid in general can also be increased by including a separate gelling agent that forms a linear gel. Examples of suitable gelling agents include guar, HPG, CMHPG and xanthan.

Also, in addition to or in lieu of a gelling agent that forms a liner gel, a cross-linkable gelling agent and a gel crosslinker capable of crosslinking the cross-linkable gelling agent can be included in the viscosifying agent of the well treatment fluid disclosed herein. The cross-linkable gelling agent and gel crosslinker can be any cross-linkable gelling agent and gel cross-linker known to those skilled in the art to form a crosslinked gel in well treatment fluids and thereby enhance the viscosity of the fluids in the formation. For example, the cross-linkable gelling agent gels the base fluid in the treatment fluid and thereby increases its viscosity. For example, the gel crosslinker functions to cross link the gel and thereby further increase the viscosity of the base fluid. For example, the increased viscosity of the base fluid allows the base fluid to transport higher quantities of particulate material. Individuals skilled in the art, with the benefit of this disclosure, will recognize the exact types and amounts of cross-linkable gelling agent and crosslinker to use, depending on factors such as the specific components used, the desired viscosity, and formation conditions.

A variety of cross-linkable gelling agents can be used, including biopolymers, synthetic polymers, or a combination thereof. Examples of suitable cross-linkable gelling agents include hydratable polymers that contain one or more functional groups, such as one or more hydroxyl, carboxyl, sulfate, sulfonate, amino, amide, phosphate and phosphonate groups. Additional examples of suitable cross-linkable gelling agents include biopolymers that include polysaccharides or derivatives thereof that contain one or more of the following monosaccharide units: galactose, mannose, glucoside, glucose, xylose, arabinose, fructose, glucuronic acid, and pyranosyl sulfate. Additional examples of suitable polymers that can be used as the cross-linkable gelling agents include, but are not limited to, xanthan gum, guar gum and derivatives thereof (such as hydroxypropyl guar and carboxymethylhydroxypropyl guar), and cellulose derivatives (such as hydroxyethyl cellulose). Additionally, synthetic polymers and copolymers that contain the above-mentioned functional groups can be used. Examples of such synthetic polymers include, but are not limited to, polyacrylate, polymethacrylate, polyacrylamide, polyvinyl alcohol, and polyvinylpyrrolidone. As a further example, the cross-linkable gelling agent molecule may be depolymerized. The term “depolymerized,” as used herein, generally refers to a decrease in the molecular weight of the gelling agent molecule.

For example, one or more cross-linkable gelling agents can be added to the well treatment fluid in an amount in the range of from about 0.1% to about 5% by weight, based on the weight of the base fluid. For example, one or more cross-linkable gelling agents can be added to the well treatment fluid in an amount in the range of from about 0.01% to about 2% by weight, based on the weight of the base fluid.

Similarly, a variety of gel crosslinkers can be used. The crosslinker functions to crosslink the cross-linkable gelling agent in the well treatment fluid to form a crosslinked gel in the well treatment fluid. Suitable gel crosslinkers comprise at least one metal ion that is capable of crosslinking the cross-linkable gelling agent. Examples include, but are not limited to, borate compounds (such as, for example, alkaline earth metal borates, alkali metal-alkaline earth borates, and mixtures thereof); zirconium compounds (such as, for example, zirconium lactate, zirconium lactate triethanolamine, zirconium carbonate, zirconium acetylacetonate, zirconium malate, zirconium citrate, and zirconium diisopropylamine lactate); titanium compounds (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; and combinations thereof. Further examples of suitable borate compounds include probertite, ulexite, nobleite, frolovite, colemanite, calcined colemanite, priceite, paternoite, hydroboracite, kaliborite, and other similar borates. For example, of the various slightly water-soluble borate compounds that can be used, colemanite, calcined colemanite, and ulexite are good examples. An example of a suitable commercially available borate-based crosslinker is “BC-140™” crosslinker available from Halliburton Energy Services, Inc. of Duncan, Okla. An example of a suitable commercially available zirconium-based crosslinker is “CL-24™” crosslinker available from Halliburton Energy Services, Inc. of Duncan, Okla. An example of a suitable commercially available titanium-based crosslinking agent is “CL-39™” crosslinking agent available from Halliburton Energy Services, Inc. of Duncan, Okla.

For example, the gel crosslinker can be added to the well treatment fluid in an amount sufficient to provide, inter alia, the desired degree of crosslinking between the cross-linkable gelling agent molecules. For example, the gel crosslinker can be added to the well treatment fluid in an amount in the range from about 0.001% to about 10% by weight, based on the weight of the water in the well treatment fluid. For example, the gel crosslinker can be added to the well treatment fluid in an amount in the range from about 0.01% to about 1% by weight, based on the weight of the water in the well treatment fluid.

In addition to or in lieu of the cross-linkable gelling agent and gel crosslinker, a gelling agent that is capable of being crosslinked by the POSS particles (hereafter referred to as a “POSS particle gelling agent”) can be used. The POSS particles can crosslink the POSS particle gelling agent to increase the viscosity of the base fluid and well treatment fluid in general. In this case, a separate crosslinker for the gelling agent is not needed.

For example, the POSS particle gelling agent can be selected from the group of guar, hydroxypropyl guar, carboxymethyl hydroxypropyl guar, xanthan, cellulose ethers such as ethyl cellulose, methyl cellulose and cellulose derivatives, diutan, diutan polysaccharide, xanthan and xanthan derivatives, and substituted and unsubstituted galactomannans including guar gum and guar derivatives. For example, the POSS particle gelling agent can be selected from the group of guar, hydroxypropyl guar, carboxymethyl hydroxypropyl guar, and xanthan.

For example, one or more gel breakers can also be included in the viscosifying agent to cause crosslinked gel and/or particles (including crosslinked POSS particles, gel crosslinked by POSS particles and gel crosslinked by another crosslinker included in the viscosifying agent) in the formation and/or wellbore to break down, thereby decreasing the viscosity of the well treatment fluid. The well can then be flowed back to remove broken gel from the formation. The gel breaker(s) can be any gel breaker(s) known to those skilled in the art to break cross-linked gel formed in well treatment fluids and thereby decrease the viscosity of the fluids in the formation. Any suitable gel breaker can be used, including encapsulated gel breakers and internal delayed gel breakers, including enzyme, oxidizing, acid buffer, or temperature-activated gel breakers. The same gel breaker(s) or separate gel breakers can be used to break crosslinked POSS particles, gel crosslinked by POSS particles and gel crosslinked by another crosslinker included in the viscosifying agent. The gel breaker(s) causes the viscous base fluid of the well treatment fluid to revert to a lower viscosity fluid that can be produced back to the surface after the well treatment fluid has been used to place the particulates in the fractures.

For example, oxidative and enzyme gel breakers can be used. For example, the gel breaker(s) can be selected from the group of bromates, chlorites, peroxides, perborates, percarbonates, perphosphates, persulfates, oxyacids, oxyanions of halogens, aminopoly carboxylic acids, phosphonates, polyhydroxy carboxylic acids and any combination thereof. Examples of peroxide gel breakers that can be used include organic and inorganic peroxides including hydrogen peroxide, calcium peroxide, magnesium peroxide and any combination thereof. For example, coated oxidative gel breakers can be used. Examples of coated oxidative gel breakers that can be used are OptiFlo II™ and OptiFlo III™ delayed-release breakers, which are available from Halliburton Energy Services, Inc.

For example, the gel breaker(s) can be added to the well treatment fluid in an amount in the range of from about 0.5% to about 10% by weight, based on the weight of the cross-linkable gelling agent(s) in the wellbore and/or formation. The gel breaker(s) breaks cross-linked gel into a linear gel or a water-like fluid.

Additional additives that can be included in the well treatment fluid used in the disclosed method include, but are not limited to, hydrocarbon fluids, air, salts, weighting agents, inert solids, fluid loss control agents, emulsifiers, dispersion aids, corrosion inhibitors, emulsion thinners, emulsion thickeners, additional viscosifying agents, surfactants, lost circulation materials, pH control additives, breakers, biocides, stabilizers, chelating agents, scale inhibitors, mutual solvents, oxidizers, reducers, clay stabilizing agents, and any combination thereof. For example, it may be advantageous to include a clay stabilizing agent in the well treatment fluid in order to minimize clay swelling.

For example, the well treatment fluid can be used as a fracturing fluid to hydraulically fracture a subterranean formation. As another example, the well treatment fluid can be used to form a diverter plug in a wellbore and/or subterranean formation. As yet another example, the well treatment fluid can be used to both hydraulically fracture a subterranean formation and form a diverter plug in the wellbore and/or formation in a single operation. The well treatment fluid can be used in other well treatment applications as well.

### Method of Treating a Subterranean Formation Penetrated by a Wellbore

The method of treating a subterranean formation penetrated by a wellbore disclosed herein comprises: providing a well treatment fluid; and pumping the well treatment fluid through the wellbore into the formation to treat the formation. The well treatment fluid used in the method is the well treatment fluid disclosed herein and described above.

In carrying out the disclosed method, the well treatment fluid is pumped through the wellbore and through one or more access conduits into the formation. As used herein and in the appended claims, an “access conduit” refers to a passageway that provides fluid communication between the wellbore and the subterranean formation, which may include, but is not limited to, sliding sleeves, open holes (for example, in non-cased areas), hydrajetted holes, perforations (for example, in cased areas), and the like.

If the well treatment fluid includes any crosslinkers and/or cross-linkable gelling agents, the well treatment fluid is pumped into the subterranean formation in a manner such that the POSS particles and/or cross-linkable gelling agents crosslink to fond crosslinked gel(s) and increase the viscosity of the well treatment fluid in the formation.

Similarly, if the POSS particles in the well treatment fluid are crosslinked, and/or the well treatment fluid in the formation includes other crosslinked gel, the method further comprises the steps of allowing the crosslinked gel to break down, thereby decreasing the viscosity of the fracturing fluid. The well can then be flowed back to remove the broken gel in the well treatment fluid from the formation.

If one or more gel breakers are included in the viscosifying agent, they may be sufficient to break the crosslinked POSS particles and any other crosslinked gel. Alternatively, the disclosed method can further comprise the step of pumping one or more gel breakers into the formation to break crosslinked gel in the well treatment fluid and thereby decrease the viscosity of the well treatment fluid. For example, one or more gel breakers can be used to break crosslinked POSS particles. For example, one or more gel breakers can be used to break crosslinked gel that has been crosslinked by one or more separate crosslinkers that are included in the viscosifying agent. For example, one or more gel breakers can be used to break crosslinked gel that has been crosslinked by the POSS particles.

The crosslinked gel formed in the well treatment fluid is allowed to break down thereby decreasing the viscosity of the well treatment fluid in the formation by allowing sufficient time for the gel breaker(s) in the well treatment fluid and/or gel breaker(s) separately pumped into the wellbore and formation to break the gel and the gel to be broken down. The well can be flowed back to remove broken gel in the well treatment fluid from the formation by any manner understood by those skilled in the art with the benefit of this disclosure. For example, the initial stage of production can be carried out in increasing step rates.

For example, the gel breaker(s) pumped into the wellbore and formation to break crosslinked gel in the well treatment fluid and thereby decrease the viscosity of the well treatment fluid can be a type of gel breaker that functions by adjusting the pH of the well treatment fluid thereby causing the crosslinked gel to break. For example, the gel breaker(s) can be one or more buffers or other pH adjusting agents that adjust the pH to a specific level, which may depend on, among other factors, the types of gelling agents, acids, and other additives included in the base fluid. For example, crosslinked POSS particles can often be broken merely by lowering the pH of the well treatment fluid.

For example, after the crosslinked gel is broken, the well treatment fluid can have a viscosity in the range of from about 5 centipoises to about 50 centipoises. The viscosity of the broken well treatment fluid allows the fluid to be removed from the formation.

For example, the method can be used to hydraulically fracture a subterranean formation. In this case, the well treatment fluid is pumped through the wellbore into the formation at a pressure above the fracture gradient of the formation to form a fracture in the formation. As another example, the method can be used to form a diverter plug in a wellbore and/or subterranean formation. As yet another example, the method can be used to both hydraulically fracture a subterranean formation and form a diverter plug in the wellbore and/or formation in a single operation. The method can used to treat wells in other ways and applications as well.

### Method of Fracturing a Subterranean Formation Penetrated by a Wellbore

In one embodiment, the method of treating a subterranean formation penetrated by a wellbore disclosed herein is a method of fracturing a subterranean formation penetrated by a wellbore, comprising: providing a fracturing fluid; pumping the fracturing fluid through the wellbore into the formation at a pressure above the fracture gradient of the formation to form a fracture in the formation; mixing a viscosifying agent with the fracturing fluid to increase the viscosity of the fracturing fluid; mixing a plurality of proppant particulates with the fracturing fluid; placing the proppant particulates in the fracture; and ceasing pumping of the fracturing fluid into the formation thereby causing the pressure at which the fracturing fluid is pumped into the formation to fall below the fracture gradient of the formation.

The fracturing fluid provided in accordance with the method includes a base fluid. The base fluid of the fracturing fluid is the base fluid described above in connection with the well treatment fluid disclosed herein. For example, the fracturing fluid can also include a dispersing agent to facilitate dispersion of the POSS particles in the base fluid. Examples of dispersing agents that can be used when the base fluid is an aqueous base fluid are set forth above in connection with the well treatment fluid disclosed herein.

In carrying out the disclosed method, the fracturing fluid is pumped through the wellbore and through one or more access conduits into the formation. As used herein and in the appended claims, the fracture gradient of a formation means the minimum pressure required to create a new fracture or expand an existing fracture in some dimension in the formation. As used herein and in the appended claims, forming a fracture in the formation means forming a new fracture or expanding an existing fracture in some dimension in the formation.

For example, the fracturing fluid can be pumped through the wellbore into the subterranean formation at a pressure above the fracture gradient of the formation to form a fracture network in the formation, the fracture network including at least one primary fracture and at least one microfracture. As used herein and in the appended claims, a “fracture network” means any and all access conduits, primary fractures, branches of primary fractures, microfractures and branches of microfractures, man-made, natural, or otherwise, that are within a subterranean formation and in fluid communication with the wellbore. For example, the fracture network may be considered a dendritic fracture network, a shattered fracture network, or any combination thereof. As used herein and in the appended claims, forming a fracture network in the formation means forming a new fracture network or expanding an existing fracture network in some dimension in the formation.

As used herein and in the appended claims, a primary fracture means a fracture that extends from the wellbore and can be propped open using primary proppant particulates. The primary fracture can be a pre-existing primary fracture or a branch thereof or a new primary fracture or branch thereof that is created by the disclosed method. A microfracture means a natural fracture or an induced secondary fracture that extends from a primary fracture or a branch thereof and that cannot be propped open using primary proppant particulates. The microfracture can be a pre-existing or natural microfracture or a branch thereof or a new microfracture or branch thereof that is created by the disclosed method.

For example, the fracturing fluid pumped through the wellbore into the subterranean formation at a pressure above the fracture gradient of the formation to form a fracture or fracture network in the formation can be a pad fracturing fluid. The pad fracturing fluid can be pumped into the formation in stages. As used herein and in the appended claims, a “pad fracturing fluid” means a fracturing fluid that forms a fracture or fracture network in the formation and does not include primary proppant particulates.

The viscosifying agent mixed with the fracturing fluid in accordance with the disclosed method is the viscosifying agent described above in connection with the well treatment fluid disclosed herein. The viscosifying agent can be mixed with the fracturing fluid before or after the fracturing fluid is first pumped through the wellbore into the formation at a pressure above the fracture gradient of the formation to form a fracture in the formation.

For example, when the base fluid is an aqueous base fluid, the POSS particles can be derivatized to increase the hydrophilicity thereof. For example, the POSS particles can be derivatized to increase the hydrophilicity thereof as described above in connection with the well treatment fluid disclosed herein.

For example, the proppant particulates mixed with the fracturing fluid can be primary proppant particulates. For example, the proppant particulates mixed with the fracturing fluid can be micro-proppant particulates. For example, the proppant particulates mixed with the fracturing fluid can be both primary proppant particulates and micro-proppant particulates.

The proppant particulates can be mixed with the fracturing fluid before or after the fracturing fluid is first pumped through the wellbore into the formation at a pressure above the fracture gradient of the formation to form a fracture in the formation. For example, if a pad fracturing fluid is used to form a fracture in the formation, primary proppant particulates are mixed with the fracturing fluid after the fracturing fluid is first pumped through the wellbore into the formation at a pressure above the fracture gradient of the formation to form a fracture in the formation.

As used herein and in the appended claims, the term “micro-proppant particulates” means particulates having a D50 particulate size distribution no greater than 30 microns. For example, the micro-proppant particulates can have a D50 particulate size distribution in the range of from about 0.01 microns to about 30 microns. For example, the micro-proppant particulates can have a D50 particulate size distribution in the range of from about 1 micron to about 25 microns. For example, the micro-proppant particulates can have a D50 particulate size distribution in the range of from about 5 microns to about 20 microns. Apart from the above definition of micro-proppant particulates, the modifier “micro” should not be construed as limiting.

As used herein and in the appended claims, the term “primary proppant particulates” means particulates having a D50 particulate size distribution of at least 35 microns. For example, the primary proppant particulates can have a D50 particulate size distribution in the range of from about 35 microns to about 800 microns, or any subset therebetween. For example, the primary proppant particulates can have a D50 particulate size distribution in the range of from about 100 microns to about 500 microns. Apart from the above definition of primary proppant particulates, the modifier “primary” should not be construed as limiting.

The primary proppant particulates used in the disclosed method can be any type of proppant particulate suitable for use in propping open primary fractures and branches thereof in subterranean formations as known to those skilled in the art. Suitable primary proppant particulates include all shapes of materials, including substantially spherical materials, low to high aspect ratio materials, fibrous materials, polygonal materials (such as cubic materials), and mixtures thereof.

The micro-proppant particulates used in the disclosed method can be any type of micro-proppant particulate suitable for use in propping open microfractures in subterranean formations as known to those skilled in the art with the benefit of this disclosure. Suitable micro-proppant particulates include all shapes of materials, including substantially spherical materials, low to high aspect ratio materials, fibrous materials, polygonal materials (such as cubic materials), and mixtures thereof. For example, the types of proppant particulates typically used as primary proppant particulates can be used as micro-proppant particulates, except the proppant particulates have a D50 particulate size distribution no greater than 30 microns as set forth above. The micro-proppant particulates can also be generated in the fracturing fluid.

Examples of micro-proppant particulates and primary proppant particulates that can be used include sand (for example natural sand), bauxite, ceramic proppant materials, glass materials, polymer materials, polytetrafluoroethylene materials, fly ash, silica flour, seed shell pieces, fruit pit pieces, composite particulates including wood composite particulates, nut shell pieces including walnut hulls (for example, ground walnut hulls), resin pre-coated proppant particulates such as resin pre-coated sand, man-made non-degradable proppant particulates, and mixtures thereof. Examples of man-made primary proppant particulates include bauxite, ceramics, and polymeric composite particulates. Suitable composite particulates include a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

For example, the primary proppant particulates can be selected from the group of sand, walnut hulls, resin pre-coated proppant particulates, man-made proppant particulates, and mixtures thereof. For example, the primary proppant particulates of the aqueous based proppant slurry disclosed herein can be natural sand.

For example, the primary proppant particulates can also include degradable materials. Suitable degradable materials include, for example, materials that deform or melt upon heating, such as thermoplastic materials, hydrolytically degradable materials, materials degradable by exposure to radiation, materials reactive to acidic fluids, or any combination thereof. For example, the degradable materials can be degraded or degradation of the materials may be initiated by temperature, presence of moisture, oxygen, microorganisms, enzymes, pH, free radicals, a delayed-release acid, such as an acid-releasing degradable material or an encapsulated acid or a treatment fluid subsequently introduced into formation.

For example, the micro-proppant particulates are selected from the group consisting of silica flour, glass beads, fly ash, ceramics, bauxite, polymer materials, polymeric composites, mica, and combinations thereof. For example, the micro-proppant particulates are selected from the group consisting of silica flour, fly ash, ceramics, polymeric composites and combinations thereof. For example, the micro-proppant particulates are selected from the group consisting of fly ash, ceramics, polymeric composites and combinations thereof. Examples of commercially available micro-proppant particulates that can be used in the disclosed method include micro-proppant particulates manufactured by Zeeospheres Ceramics, LLC and sold as “Zeeospheres N-200™” and “Zeeospheres N-600™.”

For example, the primary proppant particulates can be mixed with the base carrier fluid to form the proppant slurry in an amount in the range of from about 0.01 pounds to about 6 pounds per gallon of the slurry. For example, the primary proppant particulates can be mixed with the base carrier fluid to form the proppant slurry in an amount in the range of from about 0.01 pounds to about 1 pound per gallon of the slurry. For example, primary proppant particulates can be mixed with the base carrier fluid to form the proppant slurry in an amount in the range of from about 0.025 pounds to about 0.1 pounds per gallon of the slurry.

For example, the micro-proppant particulates can be mixed with each of the pad fracturing fluid and the proppant slurry in an amount in the range of from about 0.01 pounds to about 1 pound per gallon of the fluid or slurry. For example, the micro-proppant particulates can be mixed with each of the pad fracturing fluid and the proppant slurry in an amount in the range of from about 0.025 pounds to about 0.5 pounds per gallon of the fluid or slurry. For example, the micro-proppant particulates can be mixed with each of the pad fracturing fluid and the proppant slurry in an amount in the range of from about 0.05 pounds to about 0.2 pounds per gallon of the fluid or slurry.

As used herein and in the appended claims, a “proppant slurry” means a treatment fluid that includes primary proppant particulates. For example, when a pad fracturing fluid is pumped into the formation in accordance with the disclosed method, it can be transitioned to a proppant slurry by adding primary proppant particulates to the fracturing fluid without ceasing the pumping process or otherwise reducing the hydraulic pressure placed on the formation by the fracturing treatment. As known to those skilled in the art with the benefit of this disclosure, if needed or desired, a pill can be pumped into the formation following pumping of the pad fracturing fluid and prior to pumping of the proppant slurry in order to allow the transition from the pad fracturing fluid to the proppant slurry to be made. The proppant slurry can also be pumped into the formation in stages.

Proppant particulates (primary proppant particulates and/or micro-proppant particulates) can be placed in the fracture (or fracture network) in accordance with the disclosed method merely by mixing the proppant particulates with the fracturing fluid. For example, due to the hydraulic pressure placed on the formation during the fracturing treatment, the fracturing fluid is forced into primary fractures including any branches thereof and microfractures and branches thereof. Upon entering the fractures, the fracturing fluid places primary proppant particulates and/or micro-proppant particulates into the primary fractures and micro-proppant particulates into the microfractures.

As known to those skilled in the art with the benefit of this disclosure, various additional components and additives can be included in the fracturing fluid in order to, for example, reduce pumping friction, make it easier to pump the fluids through the wellbore and into the formation, reduce or eliminate the fluid's reaction to the formation, enhance the ability of the fluid to fracture the formation and keep the fractures open during and following the fracturing treatment, enhance the ability of the fluid to place the proppant particulates (including primary proppant particulates and micro-proppant particulates) in the fractures, and make it easier to remove the fluid and any broken down gels and the like from the formation once the fracturing treatment is complete.

For example, the fracturing fluid used in the disclosed method can include a friction reducing agent. Examples of friction reducing agents that can be used include polysaccharides, polyacrylamides and combinations thereof.

For example, in order to facilitate consolidation of the primary proppant particulates in the primary fracture in accordance with the method disclosed herein, the primary proppant particulates can be coated with a consolidating agent, and the disclosed method can further comprise the step of allowing the primary proppant particulates to consolidate in the primary fracture. The micro-proppant particulates used in the fracturing fluid can also be coated with a consolidating agent, and the disclosed method can further comprise the step of allowing the micro-proppant particulates to consolidate in the microfracture.

The consolidating agent enhances the effectiveness of the proppant particulates in propping open the fracture and prevents the proppant particulates from flowing back into the wellbore. For example, the primary proppant particulates are typically consolidated into a proppant pack within the fracture. As used herein and in the appended claims, the term “proppant pack” refers to a collection of proppant particulates consolidated together within a fracture.

Any type of consolidating agent that will enable the proppant particulates to consolidate within a fracture in the formation can be used. For example, the proppant particulates can be either pre-coated with the consolidating agent or coated with the consolidating agent on the fly as the proppant slurry (or the pad fluid in the event the micro-proppant particulates in the pad fluid are coated with a consolidating agent) is formed and pumped into the wellbore.

Consolidating agents suitable for use in the disclosed method generally comprise any compound that is capable of minimizing particulate migration. For example, the consolidating agent can be selected from the group consisting of a curable resin, a tackifying agent, and mixtures thereof. For example, the consolidating agent can be a curable resin. For example, the curable resin can be selected from the group consisting of epoxies, furans, phenolics, furfuryl aldehydes, furfuryl alcohols, and mixtures thereof. For example, the consolidating agent can be selected from the group consisting of epoxies, furans, phenolics, and mixtures thereof. For example, the consolidating agent can be a tackifying agent. For example, the tackifying agent can be selected from the group consisting of polyamides, polyesters, polycarbonates, natural resins, zeta-potential reducing agents, and mixtures thereof. For example, the tackifying agent can be selected from the group consisting of polyamides, polyesters, polycarbonates, and mixtures thereof.

Examples of commercially available consolidating agents that can be used include SANDWEDGE® adhesive substance, available from Halliburton Energy Services, Inc., and EXPEDITE® two-component resin system, also available from Halliburton Energy Services, Inc. The type and amount of consolidating agent to be used may depend upon, among other factors, the composition and/or temperature of the subterranean formation, the chemical composition of formation fluids, the flow rate of fluids present in the formation, the effective porosity and/or permeability of the subterranean formation, the pore throat size and distribution associated with the formation, and the like. Furthermore, the concentration of the consolidating agent can be varied, inter alia, to either enhance bridging to provide for a more rapid coating of the consolidating agent or to minimize bridging to allow deeper penetration into the subterranean formation. It is within the ability of one skilled in the art, with the benefit of this disclosure, to determine the type and amount of consolidating agent to use in coating the proppant particulates used in the disclosed method to achieve the desired results.

For example, the consolidating agent can be used to facilitate the consolidation of the primary proppant particulates into a proppant pack in the primary fracture. For example, the size and nature of the proppant pack can vary depending, in part, upon the specific consolidating agent used and the size of the primary proppant particulates. In wells with or projected to have high production flow rates, for example, a curable resin may be desirable for use as the consolidating agent to prevent any potential break up of the proppant mass. For example, in wells with or projected to have low production flow rates, it may be desirable to use a tackifying agent as the consolidating agent. In one embodiment, a portion of the primary proppant particulates used in the proppant slurry are coated with a curable resin, as stated above, and a portion of the primary proppant particulates used in the proppant slurry are coated with a tackifying agent, as stated above.

For example, the primary proppant particulates initially used in the treatment (for example, early in the proppant stage of a fracturing treatment) can be coated with a tackifying agent. At some point during the treatment (for example, the tail-end stage of a fracturing treatment), the primary proppant particulates used can be coated with a curable resin. In another embodiment, the primary proppant particulates can be intermittently coated with a curable resin or a tackifying agent as the proppant slurry is injected into the formation on the fly.

The proppant particulates (including the primary proppant particulates and micro-proppant particulates when they are coated with a consolidating agent) can be allowed to consolidate in the fracture by allowing a sufficient time for the consolidating agent to act (and a proppant pack to form, for example) before the fracture is allowed to close. For example, if a curable resin is used as the consolidating agent, it functions to consolidate proppant particulates and hold them together within the fracture as it hardens and cures within the fracture. If a tackifying agent is used, it causes the proppant particulates to cling together within the fracture. For example, by consolidating the primary proppant particulates, one or more proppant packs can be formed which can help prevent flow back of proppant particulates into the wellbore. As used herein and in the appended claims, a “proppant pack” means a collection of proppant particulates in a fracture network.

If the fracturing fluid includes crosslinked gel, the method can further comprise the step of breaking crosslinked gel in the wellbore and/or formation to decrease the viscosity of the fracturing fluid. This may be necessary in order to place the proppant particulates in the fracture(s). Crosslinked gel can be broken by pumping one or more gel breakers into the formation as disclosed and described above in connection with the overall method of treating a subterranean formation penetrated by a wellbore disclosed herein. The gel breaker(s) can be pumped into the formation by mixing the gel breaker with the fracturing fluid, either before the fracturing fluid is first pumped into the formation to fracture the formation or thereafter. Alternatively, the gel breaker(s) can be pumped into the formation after pumping of the fracturing fluid into the formation is ceased. If so, for example, the broken down gel can be removed from the formation by flowing back the well.

The components of the fracturing fluid can be mixed together by any method known to those skilled in the art with the benefit of this disclosure. For example, the fracturing fluid can be formed and various components can be added thereto on the site of the wellbore including on the fly as the fracturing fluid is pumped into the wellbore and the fracturing treatment is carried out. For example, the micro-proppant particulates and the primary proppant particulates can be incorporated into one or more slurries that are atomized into a pad fracturing fluid and proppant slurry, as appropriate, on the fly as the pad fracturing fluid and proppant slurry are pumped into the wellbore. For example, the micro-proppant particulates can be delivered to the well site in slurry form.

Ceasing pumping of the fracturing fluid into the subterranean formation in accordance with the disclosed method causes the pressure at which the fracturing fluid is pumped into the formation to fall below the fracture gradient of the formation. Once the pressure in the formation falls below the fracture gradient of the formation, the primary fracture and any branches thereof tend to close on top of the primary proppant particulates therein. While in place, the primary proppant particulates hold open the primary fracture(s) and branches fracture network thereby maintaining the ability for fluid to flow through the fracture network to ultimately be produced at the surface. Similarly, once the pressure in the formation falls below the fracture gradient of the formation, the microfracture(s) and any branches thereof tend to close on top of the micro-proppant particulates therein. While in place, the micro-proppant particulates hold open the microfracture(s) and branches thereby maintaining the ability for fluid to flow through the fracture network to ultimately be produced at the surface.

Although the disclosed method can be used in any subterranean formation capable of being fractured, it is particularly suitable in formations where microfractures are more prevalent. For example, such formations include, but are not limited to, formations with at least a portion of the formation characterized by very low permeability, very low formation pore throat size, high closure pressure, high brittleness index, or any combination thereof. For example, at least a portion of the subterranean formation may have a permeability ranging from a lower limit of about 0.1 nanodarcy (nD), 1 nD, 10 nD, 25 nD, 50 nD, 100 nD, or 500 nD to an upper limit of about 500 microdarcies (mD), 100 mD, 50 mD, 25 mD, 10 mD, or 1 mD, and wherein the permeability may range from any lower limit to any upper limit and encompass any subset therebetween. For example, at least a portion of the subterranean formation may have a permeability of no greater than 1 mD. One method to determine the subterranean formation permeability includes The American Petroleum Institute Recommended Practice 40, “Recommended Practices for Core Analysis,” Second Edition, February 1998.

For example, at least a portion of the subterranean formation may have an average formation pore throat size ranging from a lower limit of about 0.005 microns, 0.01 microns, 0.05 microns, 0.1 microns, 0.25 microns, or 0.5 microns to an upper limit of about 2.0 microns, 1.5 microns, 1.0 microns, or 0.5 microns, and wherein the average formation pore throat size may range from any lower limit to any upper limit and encompass any subset therebetween. One method to determine the pore throat size of a subterranean formation includes the AAPG Bulletin, March 2009, v. 93, no. 3, pages 329-340.

For example, at least a portion of the subterranean formation may have a closure pressure greater than about 500 psi to an unlimited upper limit. While the closure pressure upper limit is believed to be unlimited, formations where the disclosed method may be applicable include formations with a closure pressure ranging from a lower limit of about 500 psi, 1000 psi, 1500 psi, or 2500 psi to an upper limit of about 20,000 psi, 15,000 psi, 10,000 psi, 8500 psi, or 5000 psi, and wherein the closure pressure may range from any lower limit to any upper limit and encompass any subset therebetween. One method to determine the subterranean formation closure pressure includes the method presented in Society for Petroleum Engineers paper number 60321 titled “Case History: Observations From Diagnostic Injection Tests in Multiple Pay Sands of the Mamm Creek Field, Piceance Basin, Colo.”

For example, at least a portion of a subterranean formation may have a brittleness index ranging from a lower limit of about 5, 10, 20, 30, 40, or 50 to an upper limit of about 150, 125, 100, or 75 and wherein the brittleness index may range from any lower limit to any upper limit and encompass any subset therebetween. Brittleness is a composite of Poisson's ratio and Young's modulus. One method to determine the brittleness index of a subterranean formation includes the method presented in Society for Petroleum Engineers paper number 132990 titled “Petrophysical Evaluation of Enhancing Hydraulic Stimulation in Horizontal Shale Gas Wells.”

The method disclosed herein is particularly suitable for fracturing tight formations of unconventional reservoirs, such as formations containing shale, tight sandstone formations, coal bed formations and other formations that encounter high closure stresses. For example, the method disclosed herein can be used to fracture a shale zone of a subterranean formation.

For example, all or part of the wellbore penetrating the subterranean formation may include casing pipes or strings placed in the wellbore (a “cased hole” or a “partially cased hole”), in order to, among other purposes, facilitate production of fluids out of the formation and through the wellbore to the surface. For example, the wellbore may also be an “open hole” that has no casing.

For example, in one embodiment, the well treatment fluid disclosed herein comprises an aqueous base fluid and a viscosifying agent for increasing the viscosity of the well treatment fluid, the viscosifying agent comprising a plurality of polyhedral oligomeric silsequioxane particles that each contain at least one reactive functional end group and have been derivatized to increase the hydrophilicity thereof.

For example, in another embodiment, the well treatment fluid disclosed herein comprises a base fluid, a viscosifying agent for increasing the viscosity of the well treatment fluid and comprising a plurality of polyhedral oligomeric silsequioxane particles that each contain at least one reactive functional end group, and a crosslinker capable of reacting with the functional groups of the polyhedral oligomeric silsequioxane particles in order to crosslink the polyhedral oligomeric silsequioxane particles.

For example, in another embodiment, the well treatment fluid disclosed herein comprises a base fluid, a viscosifying agent for increasing the viscosity of the well treatment fluid and comprising a plurality of polyhedral oligomeric silsequioxane particles that each contain at least one reactive functional end group, a crosslinker capable of reacting with the functional groups of the polyhedral oligomeric silsequioxane particles in order to crosslink the polyhedral oligomeric silsequioxane particles, and a gelling agent that is capable of being crosslinked by said polyhedral oligomeric silsequioxane particles.

For example, in one embodiment, the method of treating a subterranean formation penetrated by a wellbore disclosed herein comprises providing a well treatment fluid that includes an aqueous base fluid and a viscosifying agent for increasing the viscosity of the well treatment fluid, the viscosifying agent comprising a plurality of polyhedral oligomeric silsequioxane particles that each contain at least one reactive functional end group and have been derivatized to increase the hydrophilicity thereof.

For example, in another embodiment, the method of treating a subterranean formation penetrated by a wellbore disclosed herein comprises providing a well treatment fluid that includes a base fluid, a viscosifying agent for increasing the viscosity of the well treatment fluid and comprising a plurality of polyhedral oligomeric silsequioxane particles that each contain at least one reactive functional end group, and a crosslinker capable of reacting with the functional groups of the polyhedral oligomeric silsequioxane particles in order to crosslink the polyhedral oligomeric silsequioxane particles.

For example, in another embodiment, the method of treating a subterranean formation penetrated by a wellbore disclosed herein comprises providing a well treatment fluid that includes a base fluid, a viscosifying agent for increasing the viscosity of the well treatment fluid and comprising a plurality of polyhedral oligomeric silsequioxane particles that each contain at least one reactive functional end group, a crosslinker capable of reacting with the functional groups of the polyhedral oligomeric silsequioxane particles in order to crosslink the polyhedral oligomeric silsequioxane particles, and a gelling agent that is capable of being crosslinked by said polyhedral oligomeric silsequioxane particles.

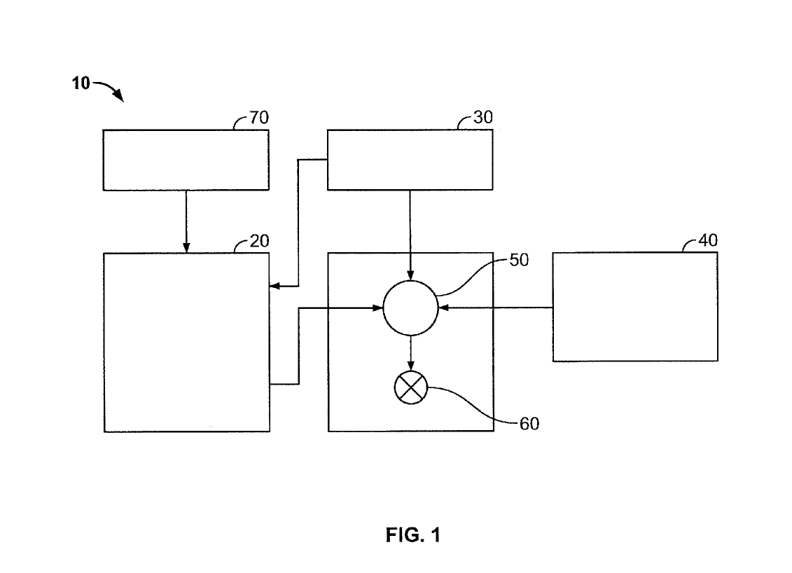

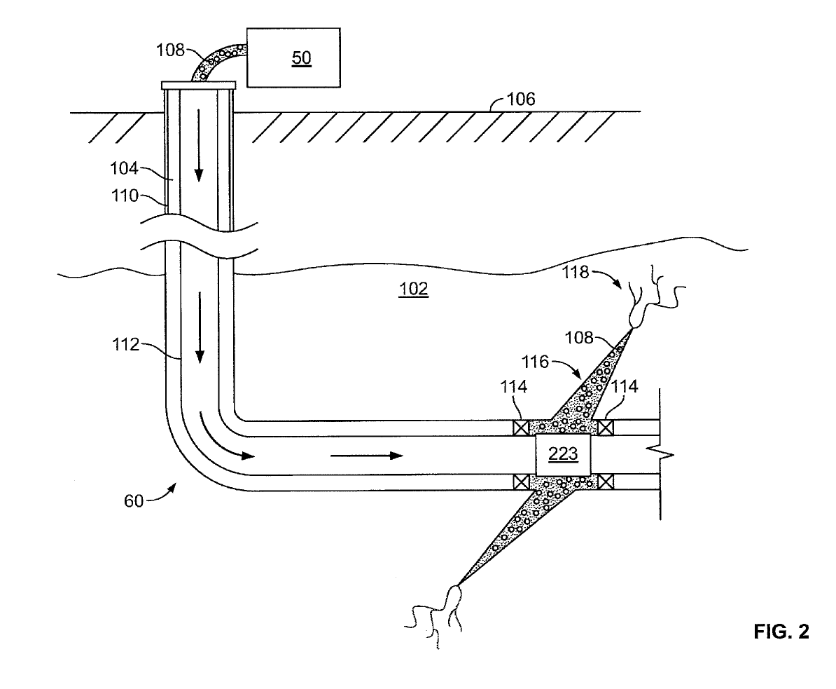

The exemplary fluids, compositions and methods disclosed herein may directly or indirectly affect one or more components or pieces of equipment associated with the preparation, delivery, recapture, recycling, reuse, and/or disposal of the disclosed fluids, compositions and methods. FIGS. 1 and 2 illustrate a typical fracturing operation.

For example, and with reference to FIG. 1, the disclosed fluids, compositions and methods may directly or indirectly affect one or more components or pieces of equipment associated with an exemplary fracturing system 10, according to one or more embodiments. In certain instances, the system 10 includes a fracturing fluid producing apparatus 20 (for example, for producing the pad fracturing fluid and proppant slurry used in the disclosed method), a fluid source 30, a proppant source 40, and a pump and blender system 50. The system 10 resides at the surface at a well site where a well 60 is located. For example, the fracturing fluid producing apparatus 20 can combine a gel precursor with fluid (e.g., liquid or substantially liquid) from fluid source 30, to produce a hydrated fracturing fluid (for example, the pad fluid and/or proppant slurry of the method disclosed herein) that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, as discussed above, the fracturing fluid may comprise water, a hydrocarbon fluid, a polymer gel, foam, air, wet gases and/or other fluids.

The proppant source 40 can include and provide the proppant (including the micro-proppant particulates and primary proppant particulates of the disclosed method) for combination with the fracturing fluid (for example, the pad fluid and proppant slurry) as appropriate. The system may also include an additive source 70 that provides one or more additives (e.g., gelling agents, weighting agents, and/or other optional additives as discussed above) to alter the properties of the fracturing fluid (for example, the pad fluid and/or proppant slurry). For example, additives from the additive source 70 can be included to reduce pumping friction, to reduce or eliminate the fluid's reaction to the geological formation in which the well is formed, to operate as surfactants, and/or to serve other functions.

For example, the pump and blender system 50 can receive the fracturing fluid (for example, the base carrier fluid) and combine it with other components, including proppant particulates from the proppant source 40 and/or additional fluid from the additive source 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppant particulates, and/or other compositions to the pump and blender system 50. Such metering devices may permit the pump and blender system 50 to source from one, some or all of the different sources at a given time, and may facilitate the preparation of fracturing fluids in accordance with the present disclosure using continuous mixing or “on the fly” methods. Thus, for example, the pump and blender system 50 can provide just fracturing fluid (for example, the pad fluid) into the well at some times, just proppant slurry at some times, just proppant particulates at other times, and combinations of those components at yet other times.

FIG. 2 shows the well 60 during a fracturing operation in a portion of a subterranean formation of interest 102 (for example, a subterranean zone) surrounding a wellbore 104. For example, the formation of interest can include one or more subterranean formations or a portion of a subterranean formation.

The wellbore 104 extends from the surface 106, and the fracturing fluid 108 (for example, the pad fluid and proppant slurry) is applied to a portion of the subterranean formation 102 surrounding the horizontal portion of the wellbore. Although shown as vertical deviating to horizontal, the wellbore 104 may include horizontal, vertical, slanted, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shaped charges, a perforating gun, hydro jetting and/or other tools.

The well is shown with a work string 112 depending from the surface 106 into the wellbore 104. The pump and blender system 50 is coupled to a work string 112 to pump the fracturing fluid 108 into the wellbore 104. The work string 112 may include coiled tubing, jointed pipe, and/or other structures that allow fluid to flow into the wellbore 104. The work string 112 can include flow control devices, bypass valves, ports, and or other tools or well devices that control a flow of fluid from the interior of the work string 112 into the subterranean zone 102. For example, the work string 112 may include ports adjacent the wellbore wall to communicate the fracturing fluid 108 directly into the subterranean foimation 102, and/or the work string 112 may include ports that are spaced apart from the wellbore wall to communicate the fracturing fluid 108 into an annulus in the wellbore between the work string 112 and the wellbore wall.

The work string 112 and/or the wellbore 104 may include one or more sets of packers 114 that seal the annulus between the work string 112 and wellbore 104 to define an interval of wellbore 104 into which the fracturing fluid 108 will be pumped. FIG. 4 shows two packers 114, one defining an uphole boundary of the interval and one defining the downhole end of the interval.

When the fracturing fluid 108 (for example, the pad fracturing fluid) is introduced into wellbore 104 (e.g., in FIG. 4, the area of the wellbore 104 between packers 114) at a sufficient hydraulic pressure, one or more primary fractures 116 and microfractures 118 are created in the subterranean zone 102. As shown, the microfractures have propagated from or near the ends and edges of the primary fractures 116. The primary proppant particulates in the fracturing fluid 108 (for example, the proppant slurry) enter the fractures 116 where they may remain after the fracturing fluid flows out of the wellbore, as described above. These primary proppant particulates may “prop” fractures 116 such that fluids may flow more freely through the fractures 116. Similarly, the micro-proppant particulates in the fracturing fluid 108 (for example, the pad fluid and the proppant slurry) enter the microfractures 118 where they may remain after the fracturing fluid flows out of the wellbore, as described above. The primary proppant particulates and micro-proppant particulates “prop” fractures 116 and 118, respectively, such that fluids may flow more freely through the fractures 116 and 118.

While not specifically illustrated herein, the disclosed fluids, compositions and methods may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

### EXAMPLES

The following example illustrates a specific embodiment consistent with the present disclosure but does not limit the scope of the disclosure or the appended claims. Concentrations and percentages are by weight unless otherwise indicated.

### Example 1

Approximately 0.2 grams of trimethylolpropane di-isobutyl polyhedral oligomeric silsequioxane particles (“TMP di-isobutyl POSS”), having structure (8) shown above, were dispersed in 1.0 milliliter of isopropanol and crosslinked with 0.3 mL of a borate crosslinker. The borate crosslinker was a combination of boric acid and monoethanolamine, which is a common crosslinker for guar based systems and has the ability to crosslink diols. In this case, the TMP di-isobutyl POSS was hydrophobic. As a result, the particles were not dispersible in water. The TMP di-isobutyl POSS readily crosslinked to form a stable gel having a relatively high viscosity.

Therefore, the present compositions and methods are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A well treatment fluid, comprising:
a base fluid; and
a viscosifying agent for increasing the viscosity of the well treatment fluid, said viscosifying agent comprising a plurality of polyhedral oligomeric silsesquioxane particles that each contain at least one reactive functional end group.

2. The well treatment fluid of claim 1, wherein said base fluid is a non-aqueous base fluid.

3. The well treatment fluid of claim 1, wherein said base fluid is an aqueous base fluid.

4. The well treatment fluid of claim 3, wherein said polyhedral oligomeric silsesquioxane particles are derivatized to increase the hydrophilicity thereof.

5. The well treatment fluid of claim 4, wherein said well treatment fluid further comprises a dispersing agent.

6. The well treatment fluid of claim 1, wherein said reactive functional end group of said polyhedral oligomeric silsesquioxane particles is selected from the group of hydroxyl groups, epoxy groups, amine groups, and carboxyl groups.

7. The well treatment fluid of claim 1, wherein said viscosifying agent further comprises a crosslinker capable of reacting with said functional groups of said polyhedral oligomeric silsesquioxane particles in order to crosslink said polyhedral oligomeric silsesquioxane particles.

8. The well treatment fluid of claim 1, wherein said viscosifying agent further comprises a gelling agent capable of being crosslinked.

9. The well treatment fluid of claim 8, wherein said gelling agent is capable of being crosslinked by said polyhedral oligomeric silsesquioxane particles.

10. A method of treating a subterranean formation penetrated by a wellbore, comprising:
providing a well treatment fluid, said well treatment fluid including:
a base fluid; and
a viscosifying agent for increasing the viscosity of the well treatment fluid, said viscosifying agent comprising a plurality of polyhedral oligomeric silsesquioxane particles that each contain at least one reactive functional end group; and
pumping said well treatment fluid through said wellbore into the formation to treat said formation.

11. The method of claim 10, wherein said base fluid is an aqueous base fluid.

12. The method of claim 11, wherein said polyhedral oligomeric silsesquioxane particles are derivatized to increase the hydrophilicity thereof.

13. The method of claim 10, wherein said viscosifying agent further comprises a crosslinker capable of reacting with said functional groups of said polyhedral oligomeric silsesquioxane particles in order to crosslink said polyhedral oligomeric silsesquioxane particles.

14. The method of claim 13, wherein said viscosifying agent further comprises a gelling agent.

15. The method of claim 14, wherein said gelling agent is capable of being crosslinked by said polyhedral oligomeric silsesquioxane particles.

16. The method of claim 10, further comprising pumping a gel breaker into the formation to break crosslinked gel in said well treatment fluid and thereby decrease the viscosity of said well treatment fluid.

17. A method of fracturing a subterranean formation penetrated by a wellbore, comprising:
providing a fracturing fluid, said fracturing fluid including a base fluid;
pumping said fracturing fluid through said wellbore into the formation at a pressure above the fracture gradient of the formation to form a fracture in the formation;
mixing a viscosifying agent with said fracturing fluid to increase the viscosity of said fracturing fluid, said viscosifying agent comprising a plurality of polyhedral oligomeric silsesquioxane particles that each contain at least one reactive functional end group;
mixing a plurality of proppant particulates with said fracturing fluid;
placing the proppant particulates in said fracture; and
ceasing pumping of said fracturing fluid into the formation thereby causing the pressure at which the fracturing fluid is pumped into the formation to fall below the fracture gradient of the formation.

18. The method of claim 17, wherein said viscosifying agent further comprises a crosslinker capable of reacting with said functional groups of said polyhedral oligomeric silsesquioxane particles in order to crosslink said polyhedral oligomeric silsesquioxane particles.

19. The method of claim 18, wherein said viscosifying agent further comprises a gelling agent capable of being crosslinked by said polyhedral oligomeric silsesquioxane particles.

20. The method of claim 19, further comprising mixing a gel breaker with said fracturing fluid to break crosslinked gel in said fracturing fluid and thereby decrease the viscosity of said fracturing fluid.

21. The method of claim 17, wherein said viscosifying agent is mixed with said fracturing fluid using mixing equipment.

22. The method of claim 17, wherein said fracturing fluid is pumped through said wellbore into the formation at a pressure above the fracture gradient of the formation using one or more pumps.
